(19) United States
(12) Patent Application Publication
(10) Pub. No.: US 2008/0192034 A1
(43) Pub. Date: Aug. 14, 2008

(54) DISPLAY DEVICE AND METHOD FOR ADJUSTING DISPLAY RESPONSE TIME

(75) Inventors: Szu-Ping CHEN, Hsinchu County (TW); Chun-Hsing HSIEH, Hsinchu City (TW); Shu-Lung CHEN, Kaohsiung City (TW); Kao-Yueh YANG, Hsinchu County (TW)

Correspondence Address: MCNEES WALLACE & NURICK LLC, 100 PINE STREET, P.O. BOX 1166, HARRISBURG, PA, 17108-1166, US

(73) Assignee: REALTEK SEMICONDUCTOR CORPORATION, Hsinchu (TW)

(21) Appl. No.: 12/028,498

(22) Filed: Feb. 8, 2008

(30) Foreign Application Priority Data
Feb. 13, 2007 (TW) 096105216

(51) Int. Cl. G09G 5/00

(52) U.S. Cl. 345/204

(57) ABSTRACT

A method for adjusting display response time includes: a) providing an overdrive table; b) determining a response time setting status; c) changing the overdrive table according to the response time setting status; d) receiving video data; and e) with reference to the video data, looking up the overdrive table changed in step c) to obtain overdrive video data. A display device that implements the method is also disclosed.

### CROSS-REFERENCE TO RELATED APPLICATION

This application claims priority of Taiwanese application no. 096105216, filed on Feb. 13, 2007.

### BACKGROUND OF THE INVENTION

1. Field of the Invention

The invention relates to flat panel displays, more particularly to a display device and method for adjusting response time of a flat panel display.

2. Description of the Related Art

Liquid crystal displays have advantages of slim size, lightweight, low power consumption, low radiation, and high compatibility with semiconductor manufacturing technology, and are widely adopted.

Under varied alignment conditions of liquid crystal molecules, optical characteristics of light passing through a liquid crystal layer may be different. Hence, through application of electric fields to alter the alignment conditions of liquid crystal molecules, the amount of light that is allowed to pass can be controlled so as to generate different intensities of outputted light. A liquid crystal display uses this characteristic to generate different intensities of red, green, and blue light when displaying an image. The applied electric field and generated intensity for every color component of each pixel can be expressed by a pixel value. For instance, (R, G, B) represents red, green and blue color components, where (0, 0, 0) indicates complete darkness (i.e., the color of black), while (255, 255, 255) indicates complete illumination (i.e., the color of white).

Since the alteration of the alignment conditions of liquid crystal molecules is a prerequisite to changes in the intensity of outputted light, the response speed is relatively slow; that is, when a pixel is changed from an initial pixel value to a target pixel value, a period of time is required to reach the target pixel value. Therefore, when the liquid crystal display is used to display fast-changing dynamic images (such as when watching a DVD film or playing a computer game) the user is likely to perceive poor display quality (for example, residual images or discontinuities are present on the screen).

In general, an overdrive scheme is used to reduce liquid crystal response time. For instance, when a pixel is to be changed from an initial pixel value (40, 40, 40) to a target pixel value (80, 80, 80), an electric field corresponding to an overdrive pixel value (120, 120, 120) is applied to the liquid crystal material so that the pixel is able to reach the target pixel value within a designated time period. On the other hand, when a pixel is to be changed from an initial pixel value (120, 120, 120) to a target pixel value (80, 80, 80), an electric field corresponding to an overdrive pixel value (40, 40, 40) is applied to the liquid crystal material so that the pixel is able to reach the target pixel value within a designated time period.

In order to obtain the overdrive pixel value in an efficient manner, an overdrive table is usually established beforehand and is looked up with reference to the initial and target pixel values, so as to obtain the overdrive pixel value.

However, since the overdrive table is fixed for each liquid crystal display and cannot be adjusted by the user, use of the overdrive table can only cause the overall liquid crystal response time to reach a preset fixed value. In addition, different users have varied viewing preferences. Therefore, when the display quality is poor, such as when the liquid crystal response time is not fast enough for the user, adjustments cannot be made to satisfy user preference.

Furthermore, when manufacturing liquid crystal displays, a source overdrive table is first generated according to average characteristics of products, and the source overdrive table is subsequently fine-tuned for each product to achieve uniform display effect. Since a lot of time is spent on fine-tuning, manufacturing costs are undesirably increased.

### SUMMARY OF THE INVENTION

Therefore, an object of the present invention is to provide a display device and method for adjusting response time of a flat panel display, which allow users to perform display response time adjustments to suit individual viewing preferences, and also reduce manufacturing costs.

According to one aspect of the present invention, there is provided a method for adjusting display response time that comprises the steps of:

a) providing an overdrive table;

b) determining a response time setting status;

c) changing the overdrive table according to the response time setting status;

d) receiving video data; and

e) with reference to the video data, looking up the overdrive table changed in step c) to obtain overdrive video data.

According to another aspect of the present invention, there is provided a method for adjusting display response time that comprises the steps of:

a) providing an overdrive table;

b) determining a response time setting status;

c) receiving video data;

d) looking up the overdrive table with reference to the video data; and

e) adjusting lookup result obtained in step d) with reference to the response time setting status to obtain overdrive video data.

According to yet another aspect of the present invention, there is provided a display device that comprises a response time setting unit, a control unit, and a display controller.

The control unit is coupled to the response time setting unit, maintains at least one overdrive table, and determines a response time setting status according to a setting of the response time setting unit.

The display controller receives video data, and generates overdrive video data for the video data through table lookup. The overdrive video data is related to the at least one overdrive table and is further related to the response time setting status.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of the preferred embodiment of a flat panel display device according to the present invention;

FIG. 2 is a schematic diagram, which illustrates the use of a slider bar to indicate a response time setting status; and

FIG. 3 is a schematic diagram, which illustrates the use of numerical symbols selectable to indicate a plurality of preset response time setting statuses, respectively.

### DETAILED DESCRIPTION OF THE PREFERRED EMBODIMENT

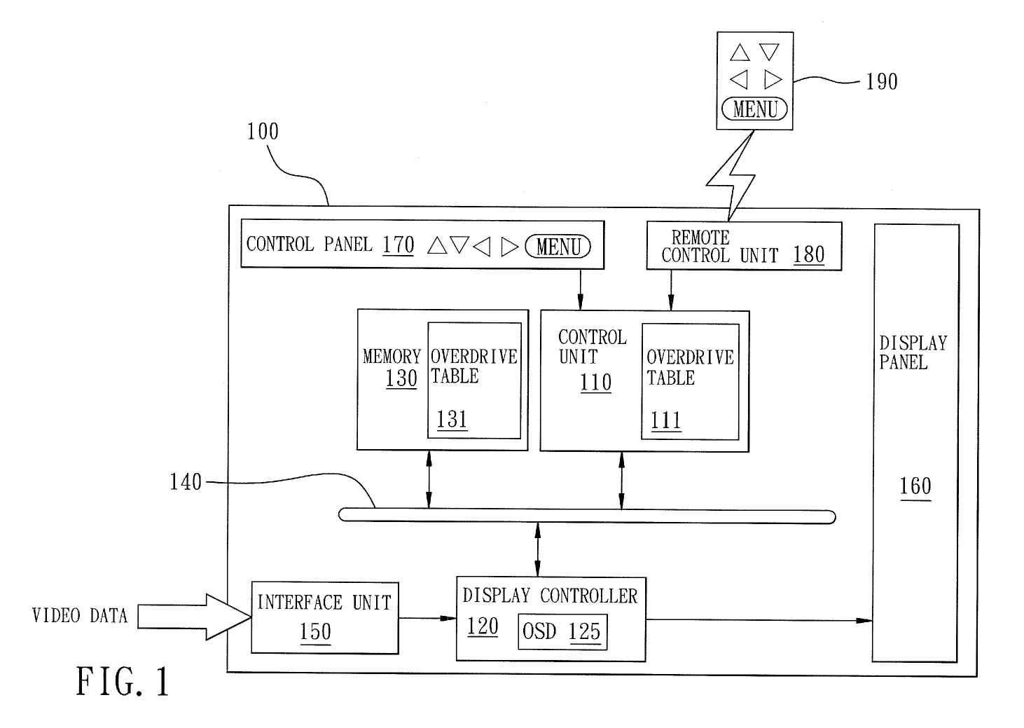

FIG. 1 shows the preferred embodiment of a flat panel display device 100 according to the present invention. In this embodiment, the flat panel display device 100 is based on liquid crystal display (LCD) technology, and can be one of a LCD monitor, a LCD TV, and a digital TV with a liquid crystal display panel. However, it should be apparent to those skilled in the art that the present invention is not limited for application to the above examples and can be further applied to other flat panel display technologies (such as plasma display technology) and non-flat panel display technologies, etc., that employ overdrive techniques. As shown in FIG. 1, the flat panel display device 100 includes a control unit 110 (which is implemented as a micro-controller unit, or MCU), a display controller 120, and a memory 130. In this embodiment, the control unit 110 and the display controller 120 access the memory 130 through a bus 140. In this embodiment, the control unit 110 and the display controller 120 are implemented using separate integrated circuit chips. However, in other embodiments of this invention, the control unit 110 and the display controller 120, as well as the memory 130, may be integrated into a single integrated circuit chip. The control unit 110 is a processor that operates in accordance with a command cluster. Depending on actual application, the display controller 120 can be a LCD controller, a LCD TV controller, a digital TV controller, etc.

In this embodiment, the control unit 110 has a source overdrive table 111 pre-established therein. During initialization setting or at any other appropriate point of time, the control unit 110 loads content of the source overdrive table 111 into the memory 130 to result in a temporary overdrive table 131, which is to be accessed by the display controller 120. In general, for a flat panel display device 100, the display controller 120 is used to receive video data of a video source via an interface unit 150, to perform video processing such as de-interlacing, scaling, color and contrast processing, etc., on the video data received thereby, and to output processed video data for driving a display panel 160 so as to display an image. In order to adjust (usually, to speed up) display response time, aside from the aforesaid video processing, the display controller 120 performs table lookup using the temporary overdrive table 131 stored in the memory 130 with reference to initial pixel values and target pixel values in corresponding positions of two adjacent image frames or image fields of the video data (which could be pre-processing video data, video data that is being processed, or processed video data), so as to output overdrive pixel values for response time adjustment.

The preferred embodiment of the present invention provides flexibility whenever the user intends to adjust the response time to suit individual viewing preferences. As shown in FIG. 1, the user can operate a control panel 170 that is commonly found on the flat panel display device 100 or a remote controller 190 that is operably associated with a remote control unit 180 to alter response time setting of the flat panel display device 100. In accordance with changes made by the user to the value of the response time setting, the control unit 110 will make corresponding changes to the temporary overdrive table 131 stored in the memory 130 such that there will be corresponding changes in subsequent table lookup results by the display controller 120, in order to finally adjust the display panel response time.

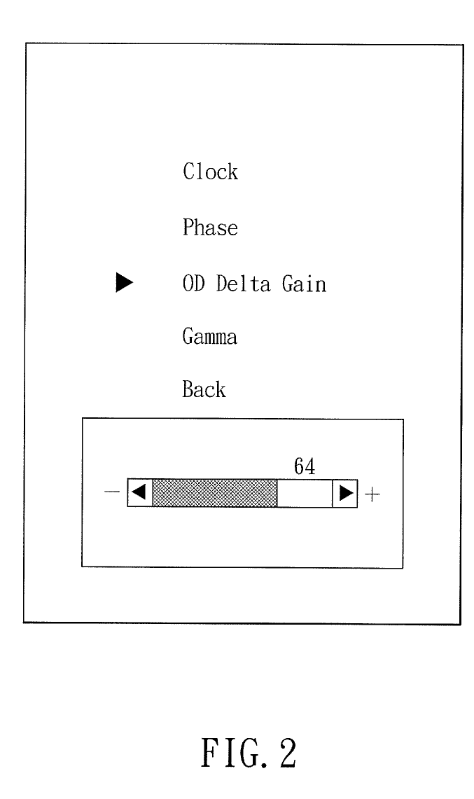

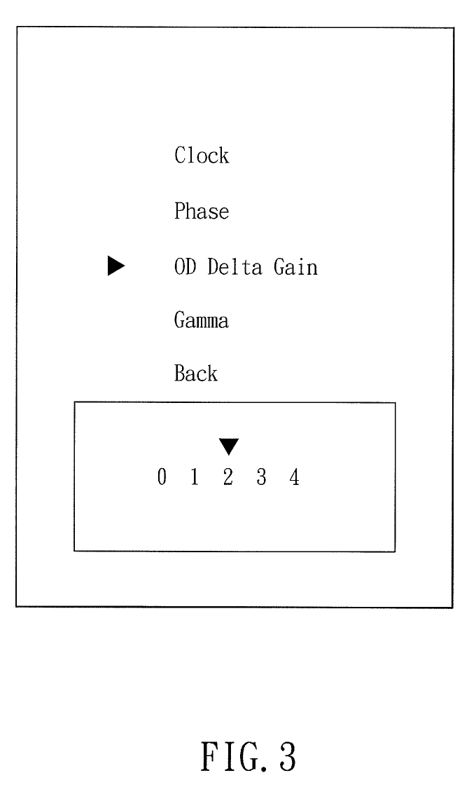

Preferably, an onscreen display setup menu generated by an onscreen display (OSD) unit 125 of the display controller 120 is made available to the user when setting is conducted through the control panel 170 and/or the remote controller 190. Referring to FIG. 2, the onscreen display setup menu may incorporate a slider bar to indicate response time setting status. Alternatively, referring to FIG. 3, the onscreen display setup menu may present a plurality of numerical symbols, which are available for selection, to indicate a plurality of preset response time setting statuses, respectively. It is noted that other schemes may be utilized to indicate the response time setting status. To update the temporary overdrive table 131, values in the source overdrive table 111 may be multiplied by a ratio value that corresponds to the response time setting status, and the new overdrive table generated as a result of the multiplication is used to update the temporary overdrive table 131 in the memory 130. Alternatively, a plurality of the source overdrive tables 111 may be pre-established in the control unit 110; then, one of the source overdrive tables 111 is selected according to the response time setting status to update the temporary overdrive table 131 in the memory 130.

In this embodiment, when adjusting the display panel response time of the flat panel display device 100, the temporary overdrive table 131 in the memory 130 is updated such that the display controller 120 performs table lookup using the updated temporary overdrive table 131. However, the present invention should not be limited thereto. In other embodiments of the present invention, the overdrive table 131 in the memory 130 is not updated by the control unit 110; instead, with reference to the response time setting status decided by the user, the control unit 110 generates a corresponding control signal for the display controller 120. In response to the control signal, the display controller 120 performs computation processing, such as multiplying the table lookup result by a ratio value corresponding to the response time setting status, so as to change the response time. Moreover, it is also possible to adjust pixel values according to the control signal, and then perform table lookup with reference to the adjusted pixel values. Therefore, adjustment of the response time does not involve the memory 130, and the display controller 120 can use the original source table 111 in the control unit 110 for table lookup.

In sum, in the preferred embodiment of this invention, through change of a response time setting status, the user is able to change outputted overdrive pixel values so as to achieve a desired response time and a preferred viewing effect. In addition, since users are able to change the response time setting status on their own, manufacturers are no longer required to fine-tune source overdrive tables of individual liquid crystal displays, thereby resulting in lower manufacturing costs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for adjusting display response time, said method comprising the steps of:
a) providing a first overdrive table;
b) determining a response time setting status;
c) changing the first overdrive table according to the response time setting status;
d) receiving video data; and
e) with reference to the video data, looking up the first overdrive table changed in step c) to obtain overdrive video data.

2. The method as claimed in claim 1, wherein step b) includes operating one of a control panel and a remote controller to determine the response time setting status.

3. The method as claimed in claim 1, wherein step c) includes multiplying values in the first overdrive table by a ratio value.

4. The method as claimed in claim 1, wherein step c) includes using a second overdrive table to replace the first overdrive table.

5. The method as claimed in claim 1, wherein, in step e), the first overdrive table changed in step c) is looked up with reference to an initial pixel value and a target pixel value in the video data to obtain an overdrive pixel value.

6. A method for adjusting display response time, said method comprising the steps of:
a) providing an overdrive table;
b) determining a response time setting status;
c) receiving video data;
d) looking up the overdrive table with reference to the video data; and
e) adjusting lookup result obtained in step d) with reference to the response time setting status to obtain overdrive video data.

7. The method as claimed in claim 6, wherein step b) includes operating one of a control panel and a remote controller to determine the response time setting status.

8. The method as claimed in claim 6, wherein step e) includes multiplying the lookup result by a ratio value.

9. The method as claimed in claim 6, wherein, in step d), the overdrive table is looked up with reference to an initial pixel value and a target pixel value in the video data to obtain an overdrive pixel value.

10. A display device comprising:
a response time setting unit;
a control unit coupled to said response time setting unit for maintaining at least one first overdrive table and for determining a response time setting status according to a setting of said response time setting unit; and
a display controller for receiving video data and for generating overdrive video data for the video data through table lookup, wherein the overdrive video data is related to said at least one first overdrive table and is further related to the response time setting status.

11. The display device as claimed in claim 10, wherein said response time setting unit includes at least one of a control panel and a remote controller.

12. The display device as claimed in claim 10, further comprising a memory coupled to said control unit and said display controller for storing a temporary overdrive table.

13. The display device as claimed in claim 12, wherein the temporary overdrive table is generated by changing said at least one first overdrive table according to the response time setting status.

14. The display device as claimed in claim 12, wherein said control unit maintains a plurality of said first overdrive tables, and the temporary overdrive table is one of said first overdrive tables selected according to the response time setting status.

15. The display device as claimed in claim 10, wherein said display controller changes a result of the table lookup according to the response time setting status to generate the overdrive video data.

16. The display device as claimed in claim 10, wherein said display controller is a LCD controller.

17. The display device as claimed in claim 10, wherein said display controller is a LCD TV controller.

18. The display device as claimed in claim 10, wherein said display controller is a digital TV controller.

19. The display device as claimed in claim 10, wherein the display device is one of a LCD monitor, a LCD TV and a digital TV.
